(19) United States
(12) Patent Application Publication
(10) Pub. No.: US 2011/0057139 A1
(43) Pub. Date: Mar. 10, 2011

(54) THREADED SEAT FITTING FOR BACK SEAT VALVES

(76) Inventor: THOMAS C. TRENT, Fort Wayne, IN (US)

(21) Appl. No.: 12/879,313

(22) Filed: Sep. 10, 2010

Related U.S. Application Data
(60) Provisional application No. 61/241,060, filed on Sep. 10, 2009.

(51) Int. Cl. F16K 1/42

(52) U.S. Cl. 251/359

(57) ABSTRACT

A back seating service valve for air conditioning systems is provided wherein the valve includes an insert fitting having a valve seat. The insert fitting is attached to the valve body using a threaded connection that is then brazed to ensure that the insert fitting does not separate from the valve body during use.

### CROSS REFERENCE TO RELATED APPLICATIONS

The present application claims the benefit of the filing date of U.S. Provisional Patent Application Ser. No. 61/241,060, filed Sep. 10, 2009, the disclosure of which is incorporated herein by reference in its entirety.

### TECHNICAL FIELD

The present invention relates to valves which have a service port to enable evaluation of fluid in a fluid system and in particular to a valve utilizing a valve seat insert for back seat valves of the type typically used in residential air conditioning systems and commercial refrigeration systems.

### BACKGROUND

Back seating valves with service ports are known, and are used in a variety of applications, for example in refrigeration systems. The valve is located in a fluid system and includes first, second, and third fluid passages. The first and second passages comprise the inlet and outlet passage for the valve, while the third passage comprises a service port. A valve element can be moved between open, intermediate, and closed positions in the valve to i) allow fluid to pass from the inlet passage to the outlet passage in the valve substantially uninterrupted during normal system operation (open position); ii) open a flow path to the service port for evacuation, charging, reclaiming and pressure-tapping the system (intermediate position); or iii) completely close the flow path between the first and second passages during shipping and maintenance (closed position). The valve element is typically externally accessible to allow manual manipulation of the valve into the respective positions, although the valve could also be operated automatically using electromechanical devices (e.g., solenoids, etc.).

Many of the commercially-available back seating valves include a valve seat insert fitting. The use of the valve seat insert fitting allows the valve element to be inserted into the valve and then captured within the valve when the valve seat insert is attached to the valve body, typically with a press fit and a brazing operation.

The seat fitting provides a valve seat when the stem is fully extended. The seat fitting must stay attached to the main body of the valve while having a large compressive load applied to it by the stem to enable completion of a metal-to-metal seal. Using a press-brazed attachment may allow the seat fitting to be pressed off the valve body if the press or brazing processes are not fully in control.

### SUMMARY

At least one embodiment of the invention provides a fluid service valve comprising: a valve body having first, second and third fluid passages, the first and second fluid passages being fluidly interconnected; a seat insert fitting threadably attached to the main body and brazed to the valve body, the seat insert fitting including a valve seat; a valve element including a stem and a valve head, the stem being received within a central bore in the valve body and moveable to bring the valve head into and out of engagement with the valve seat of the seat insert fitting to close or open a flow path to the third fluid passage.

### BRIEF DESCRIPTION OF THE DRAWINGS

Embodiments of this invention will now be described in further detail with reference to the accompanying drawings, in which:

FIG. 1 is a cross-sectional view of an embodiment of the valve in accordance with the present invention;

FIG. 2 is a side elevational view of the valve of FIG. 1;

FIG. 3 is a top view of the valve of FIG. 1; and

FIG. 4 is a detail view of the seat insert shown threaded-brazed to a valve in accordance with an embodiment of the present invention.

### DETAILED DESCRIPTION

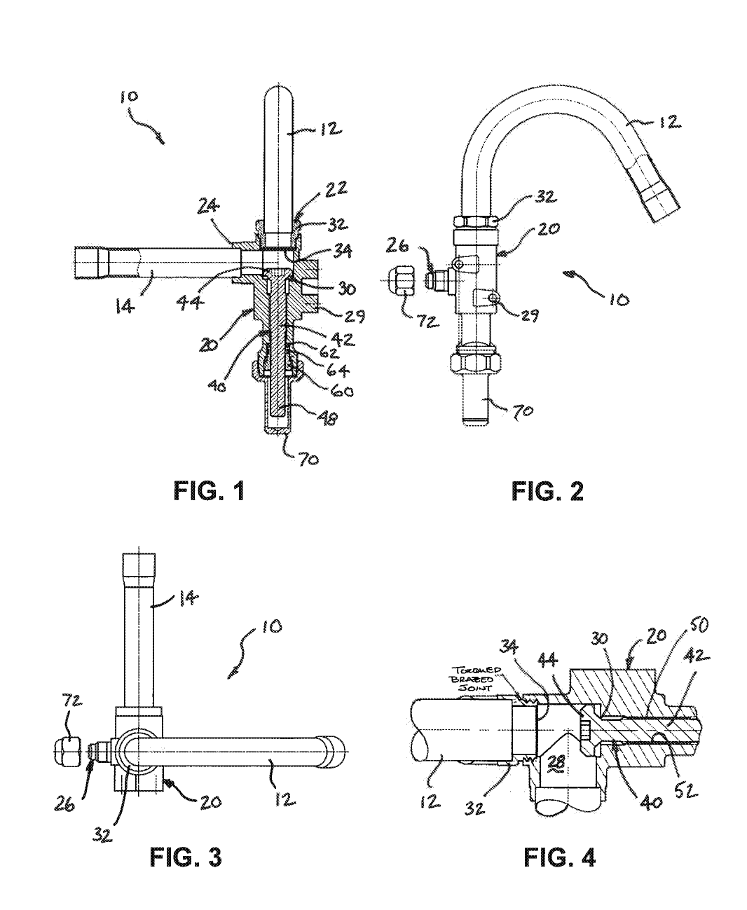

Referring to the drawings, FIGS. 1-4, a fluid service valve constructed according to the principles of the present invention is indicated generally at 10. Valve 10 comprises a valve body 20 having a first fluid passage or inlet port 22 and a second fluid passage or outlet port 24, and a third passage or service port 26. The fluid passages or ports 22, 24, 26 open into a valve chamber 28 located centrally in the valve body 20 which fluidly interconnects the ports 22, 24, 26. The valve body 20 includes an integral first or back valve seat 30 at one end of the valve chamber 28. The inlet port 22 comprises an insert fitting 32 threadably attached to the valve body 20 and brazed to the valve body 20. The insert fitting 32 comprises a second or front valve seat 34. The threaded attachment of the insert fitting 32 will prevent the insert fitting 32 from coming off the valve body 20 on the occasion of a weak braze.

First and second copper tubes 12, 14 are fixed (e.g., brazed, welded, etc.) to insert fitting 32 and second port 24, respectively. First and second tubes 12, 14 can be fluidly connected in an appropriate manner (e.g., brazed or welded) within a fluid system, such as a refrigeration system, as should be appreciated by those of ordinary skill in the art. Typically, first tube 12 is an inlet tube directing fluid in the system to first port 22, which is considered an inlet port; and second port 14 functions as an outlet port directing fluid to a second tube 14, which is considered an outlet tube—but it should be appreciated that the valve 10 could be connected in a reverse manner, or the fluid system could operate in reverse, so that the terms “inlet” and “outlet” should be considered interchangeable.

The valve 10 further comprises a valve element 40 including an elongated stem 42 and an integral, enlarged valve head 44, the stem 42 having an externally threaded portion 50 being threadably received within a threaded through-bore 52 in the valve body 20 and including an end portion 48 projecting outwardly from an end of the valve body 20 and is externally accessible. The end portion 48 of the valve stem 42 is formed with an appropriate geometry (e.g., square or hex) to enable a tool (e.g., a wrench) to rotate the valve stem 42 within the valve body 20. The valve head 44 has a circular configuration, and includes an annular tapered portion on its back (downstream) surface, which sealingly engages the back valve seat 36 when the valve element 40 is rotated in one direction into an open position. The valve head 44 also has an annular tapered portion on its front (upstream) surface, which sealingly engages the front valve seat 34 when the valve element 40 is rotated in an opposite direction into a closed position. The valve stem 42 and valve head 44 are preferably formed unitary with each other, although it is possible that they could be formed of separate pieces, and later secured together. In any case, the valve element 40 is preferably also formed of a material appropriate for the particular application, such as steel, although again, the valve stem could be formed of less-expensive and lighter weight material than steel, such as a plastic or elastomer.

The valve 10 further comprises a valve plug 60 attached to the valve body 20 that provides a fluid-tight seal between the valve plug 60 and the valve body 20 and between the valve plug 60 and the stem 42 of the valve member 40. An O-ring seal 62 carried by a channel in the valve plug 60 provides a fluid seal between valve plug 60 and valve stem 42 when the stem 42 is rotated. Another O-ring seal 64 provides a seal between the valve plug 60 and the valve body 20.

After assembly of the valve 10 and the connection of the valve 10 within a fluid system, the valve 10 can be used in open, closed or intermediate positions. The valve 10 is useful for normal system operation where the valve element 40 is secured into an open position where the valve head 44 is in sealing engagement with the back valve seat 30 and fluid can flow substantially uninterrupted (without significant pressure drop) from the inlet passage 22 to the outlet passage 24. The valve element 40 can also be moved into a closed position, where the valve head 44 is in sealing engagement with the front valve seat 34, to prevent fluid flow through the valve 10 during maintenance and shipping. The valve element 40 can still further be moved into an intermediate position, where the valve head 44 is spaced from both the front and back valve seats 30, 34, such that a flow path is opened to the service passage 26. The flow path can be used for evacuating, charging, reclaiming and pressure tapping the system. 10.

As indicated above, the valve stem 42 extends outwardly from the end of the valve body and can be rotated to screw the valve element into or out of the valve body 20. When the valve element 40 is not being so rotated, a cup-shaped cap 70 can be attached to valve body 20 to protect the valve stem 42 and valve plug 60 from external elements. Likewise, service port 26 is protected by a cap 72, when the service port 26 is not being used.

It should be noted that first port 22 intersects one end of valve body 20, and both second and third ports 24 and 26 intersect the body essentially perpendicular to the first port 22, but this is merely for illustration purposes, and second and third ports 24 and 26 could intersect the valve body 20 at other than perpendicular angles. Valve body 20 is preferably formed of a light weight-metal (e.g., brass) using conventional techniques (e.g., molding, shaping, stamping). Finally, valve body 20 can include an integral flange or embossment as at 29 to enable the body to be secured at an appropriate location in the fluid system.

Although the principles, embodiments and operation of the present invention have been described in detail herein, this is not to be construed as being limited to the particular illustrative forms disclosed. They will thus become apparent to those skilled in the art that various modifications of the embodiments herein can be made without departing from the spirit or scope of the invention.

What is claimed is:

1. A fluid service valve comprising:
a valve body having first, second and third fluid passages, the first and second fluid passages being fluidly interconnected, the valve body having a first valve seat;
a seat insert fitting threadably attached to the main body and brazed to the valve body, the seat insert including a second valve seat;
a valve element including a stem and a valve head, the stem being received within a central bore in the valve body and moveable to bring the valve head into and out of engagement with the first valve seat to close or open a flow path to the first fluid passage, and with the second valve seat to close or open a flow path to the third fluid passage.

2. The fluid service valve as in claim 1, wherein an end portion of the valve stem projects externally from the valve body and can be accessed to move the valve element.

3. The fluid service valve as in claim 1, wherein both the valve body and the valve stem have corresponding threads that enable the valve element to be screwed into and out of sealing engagement with the first and second valve seats.

4. The fluid control valve as in claim 1, wherein a valve plug is attached to the valve body and provides a fluid-tight seal between the valve plug and the body and the valve plug and the stem.

5. The fluid control valve as in claim 4, wherein an O-ring seal is provided between the valve stem and the valve plug to provide a fluid-tight seal therebetween.

6. The fluid service valve as in claim 4, wherein an O-ring seal is provided between the valve body and the valve plug to provide a fluid-tight seal therebetween.

7. A fluid service valve, comprising:
a valve body having an inlet passage and an outlet passage which are fluidly interconnected, and a service passage, the valve body having a back valve seat;
an insert fitting threadably attached to the main body and brazed to the valve body, the insert fitting including a front valve seat;
a valve element including an elongated stem and an integral, enlarged valve head, the stem being threadably received within a threaded through-bore in the valve body and including an end portion projecting outwardly from a downstream end of the valve body and externally accessible and rotatable in one direction to bring the valve head into sealing engagement with the back valve seat to prevent flow from the inlet and outlet passages to the service port, and rotatable in another direction into an intermediate position to bring the valve head out of sealing engagement with the back valve seat to open the flow path to the service port, and further rotatable in the other direction into a closed position to bring the valve head into sealing engagement with the front valve seat to prevent fluid flow between the inlet and the outlet passages.

8. The fluid control valve as in claim 7, wherein a valve plug is attached to the valve body and provides a fluid-tight seal between the valve plug and the body and the valve plug and the stem.

9. The fluid control valve as in claim 8, wherein an O-ring seal is provided between the valve stem and the valve plug to provide a fluid-tight seal therebetween.

10. The fluid service valve as in claim 8, wherein an O-ring seal is provided between the valve body and the valve plug to provide a fluid-tight seal therebetween.
